(19) United States
(12) Patent Application Publication
(10) Pub. No.: US 2008/0147536 A1
(43) Pub. Date: Jun. 19, 2008

(54) SYSTEM AND METHOD FOR PROVIDING FUNDING

(76) Inventor: Paul Alexander Breen, Newport (GB)

Correspondence Address: DICKE, BILLIG & CZAJA, FIFTH STREET TOWERS, 100 SOUTH FIFTH STREET, SUITE 2250, MINNEAPOLIS, MN, 55402, US

(21) Appl. No.: 11/949,957

(22) Filed: Dec. 4, 2007

Related U.S. Application Data
(60) Provisional application No. 60/868,377, filed on Dec. 4, 2006.

(51) Int. Cl. G06Q 20/00; G06Q 40/00

(52) U.S. Cl. 705/38; 705/40

(57) ABSTRACT

Systems and methods of providing funding from a funds provider to a worker of a client, for example payroll obligations of an employer to an employee. Worker information identifying at least one worker of the client is received, as is pay information. A request for payment of a worker payment obligation (WPO) owed by the client to the at least one worker is submitted to the funds provider, and is paid by the funds provider. An invoice is created from the funds provider to the client regarding the payment made on the client's behalf, and is transmitted to the client. In some embodiment, a revolving protocol is established for the client in which repayments are made available to client for future WPO payment requests.

### CROSS-REFERENCE TO RELATED APPLICATIONS

This application claims priority under 35 U.S.C. §119(e)(1) to U.S. Provisional Patent Application Ser. No. 60/868,377, filed Dec. 4, 2006, entitled “System and Method for Providing Funding,” and bearing Attorney Docket No. Q549.101.101 and the entire teachings of which are incorporated herein by reference.

### BACKGROUND

Successful operation of a business typically requires sufficient funds. Funds may be used to pay for the operating expenses of the company, such as rent, utility bills, and payroll. Funds may also be used for expanding the business, such as increasing office space, purchasing new equipment, and hiring new workers. Funds may come from any of a variety of sources, such as revenue, working capital, and venture capital.

Businesses sometimes experience periods where additional funds are necessary or preferable. For example, a business seeking expansive growth may desire to allocate as much available funds as possible to further that growth.

For these and other reasons, there is a need for the present disclosure.

### SUMMARY

Some aspects in accordance with principles of the present disclosure relate to a method of providing funding from a funds provider to a designated worker of a client, such as in meeting an employer's wage obligations to its employees (or other workers such as contracted third party individuals or entities). The funds provider receives from the client worker information identifying at least one worker. A request for funding is delivered by the client to the funds provider reciting pay information regarding the worker, including worker payment obligations (WPO) owed by the client to the worker. The funds provider pays the WPO according to the pay information. An invoice is created by the funds provider to the client regarding the payment(s) made on the client's behalf, and is transmitted to the client. In some embodiments, the client is given a fixed period within which to repay the funds provider the invoiced amount, and fees can be charged (in addition or as an alternative to an optional service charge) for an unpaid balance at the end of the fixed period. In other embodiments, the method includes establishing a revolving WPO funding protocol in which the client has timely access to repaid amounts against which a subsequent WPO request can be approved and paid by the funds provider.

### BRIEF DESCRIPTION OF THE DRAWINGS

The accompanying drawings are included to provide a further understanding of the present disclosure and are incorporated in and constitute a part of this specification. The drawings illustrate the embodiments of the present disclosure and together with the description serve to explain the principles of the disclosure. Other embodiments of the present disclosure and many of the intended advantages of the present disclosure will be readily appreciated as they become better understood by reference to the following detailed description. The elements of the drawings are not necessarily to scale relative to each other. Like reference numerals designate corresponding similar parts.

FIG. 1 is a flow diagram illustrating one embodiment of a method of applying for WPO funding.

FIG. 2 is a block diagram illustrating one embodiment of a system for applying for WPO funding.

FIG. 3 is a flow diagram illustrating one embodiment of a method of providing WPO funding.

FIG. 4 is a block diagram illustrating one embodiment of a system for providing WPO funding.

FIG. 5 is a screenshot illustrating one embodiment of an online application screen.

FIG. 6 is a screenshot illustrating one embodiment of a company selection screen.

FIG. 7 is a screenshot illustrating one embodiment of a company address screen.

FIG. 8 is a screenshot illustrating one embodiment of a broker login screen.

FIG. 9 is a screenshot illustrating one embodiment of a broker area screen.

FIG. 10 is a screenshot illustrating one embodiment of a submit prospect screen.

FIG. 11 is a screenshot illustrating one embodiment of a request info screen.

FIG. 12 is a screenshot illustrating one embodiment of a calculate fees screen.

FIG. 13 is a screenshot illustrating one embodiment of a prospect status screen.

FIG. 14 is a screenshot illustrating one embodiment of a client list screen.

FIG. 15 is a screenshot illustrating one embodiment of a client login screen.

FIG. 16 is a screenshot illustrating one embodiment of a client area screen.

FIG. 17 is a screenshot illustrating one embodiment of a change password screen.

FIG. 18 is a screenshot illustrating one embodiment of a manage employees screen.

FIG. 19 is a screenshot illustrating one embodiment of a create payroll screen.

FIG. 20 is a screenshot illustrating one embodiment of a manual payroll entry screen.

FIG. 21 is a screenshot illustrating one embodiment of an upload payroll file screen.

FIG. 22 is a screenshot illustrating one embodiment of a client's request for WPO funding and approved by a funds provider.

FIG. 23 is a screenshot illustrating one embodiment of a client's request for WPO funding and rejected by a funds provider

### DETAILED DESCRIPTION

In the following Detailed Description, reference is made to the accompanying drawings, which form a part hereof, and in which is shown by way of illustration specific embodiments in which the disclosure may be practiced. The following detailed description, therefore, is not to be taken in a limiting sense, and the scope of the present disclosure is defined by the appended claims.

In general terms, systems and methods in accordance with the present disclosure provide an employer-type entity with the ability to meet payment obligation(s) to the entity's worker(s) via funding (for example, direct payment to the worker) from a funds provider on an automated or electronic basis. Thus, the employer-type entity can be referred to as a “client” of the funds provider. With this in mind, the funds provider first approves and registers an applicant (i.e., potential client) as a client, and then facilitates funding of the client's worker payment obligations in accordance with various parameters described below. As used herein, the term “worker” includes all individuals and entities under a worker payment obligation (WPO). A worker may include salaried employees, hourly employees, independent contractors, subcontractors, officers or directors (paid as employees), and other businesses (e.g., a janitorial service). As used herein, the term “WPO” includes all obligations of payment to be made to an individual or entity for services performed. The WPO may include salaries, wages, and other agreed to renumeration, along with any applicable withholdings and deductions. In the context of a typical employer-employee relationship, then, at the end of an employer-designated pay period, the worker is deemed to have “earned” a gross salary or wage (the WPO), with a portion of this earned amount being delivered directly to the worker (e.g., net wage) and a portion of the earned amount be delivered to a governmental organization(s) (e.g., statutory deductions). Thus, reference to a WPO payment for a particular worker includes all portions/payments attributable to an earned amount of the worker. The present disclosure is not limited, however, to the typical employer-employee relationship.

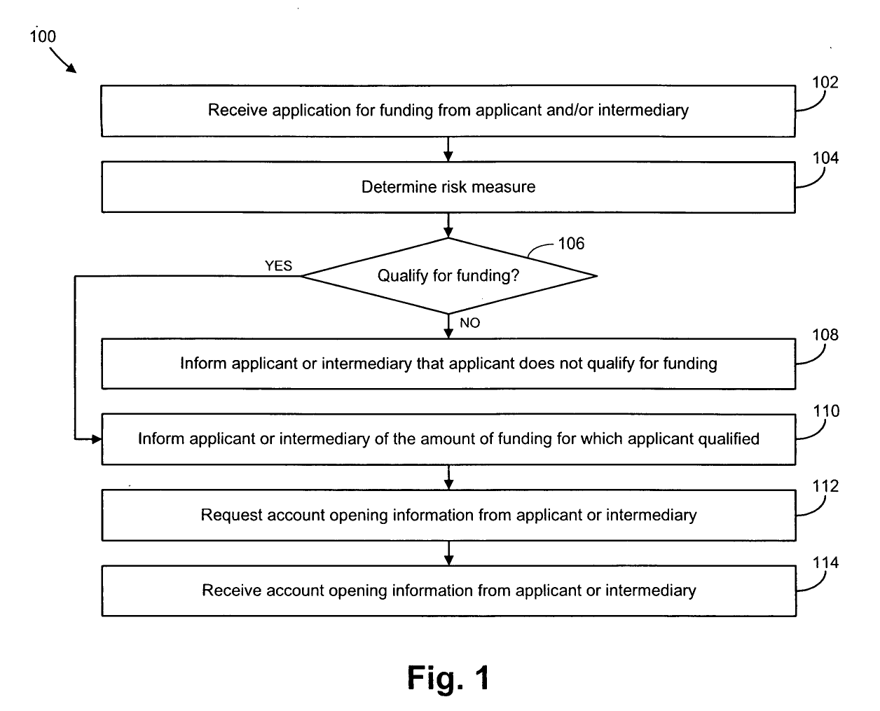

FIG. 1 is a flow diagram illustrating one embodiment of a method 100 of an applicant applying for a client relationship with a WPO funds provider. An application from an applicant to receive WPO funding as a client of the funds provider is received (at 102). The application may be sent directly from the applicant or through an intermediary. In one embodiment, the application is sent from an independent broker representing the applicant. The broker may receive a finder's fee for the transaction. The application may be provided through any suitable application conduit, including postal mail, telephone, and electronic transmission. In one embodiment, application forms are provided to the broker or applicant to apply for WPO funding. In another embodiment, separate forms are provided for a broker applying for an applicant and for an applicant applying directly. In another embodiment, a website provides separate online forms for a broker applying for an applicant and for an applicant directly. Access to the online forms for the broker may require confirmation of the identity of the broker, such as through the entry of a username and password.

Information collected in the application includes, in some embodiments, one or more identifying indicia of the applicant, such as the applicant name, the address, and a registration/identification number. The information collected may further include the name of the primary contact for the applicant, the contact information for the primary contact, and the amount of funding being requested. In one embodiment, the information collected when an applicant applies directly to the funds provider includes an option for the applicant to enter a promotional code. Promotional codes, which can be created by the funds provider during marketing campaigns, enable the funds provider to trace the source where the applicant learned of the application. An inducement, such as a discount or prize, may be provided to entice the applicant to enter the promotional code. In other embodiments, the information collected in the application may include any suitable information for determining the creditworthiness of the applicant.

A risk measure is determined (at 104) by the funds provider on the applicant. The risk measure determines the applicant's ability to repay a given funding amount based on past and/or current financial data. In particular, if the applicant is determined to have a greater ability to pay back a given funding amount, the funds provider is more likely to approve funding and/or agree to the funding amount requested by the applicant and/or increase the requested funding amount. If the applicant is determined to have a lesser ability to consistently pay back a given funded amount, the funds provider is more likely to deny any funding of the applicant and/or only agree to a funding amount that is less than that requested by the applicant. In some embodiments, the risk measure determination determines whether an applicant qualifies for funding and determines the amount of funding that will be made available to the applicant following enrollment as a client. In other embodiments, the risk measure determines whether an applicant qualifies for a requested amount of funding. In further embodiments, the determined funding amount is characterized in terms of payroll pay periods expected of the applicant (e.g., funding by the funds provider will be limited to multiples of monthly or weekly payrolls).

In some embodiments, the risk measure is performed locally by querying the applicant in a risk database. The risk database can be provided by a credit reporting agency, such as Experian, Equifax, TransUnion, and Creditsafe. The database matches the applicant with a given funding limit. In other embodiments, the risk measure is outsourced by the funds provider to an external business, such as an insurer's underwriting team. In yet other embodiments, the risk measure is performed locally by the funds provider when the applicant's requested funding is below a certain amount and is outsourced when the applicant's requested funding is above a certain amount.

If the applicant is determined (at 106) to not qualify for WPO funding by the funds provider, then the applicant or the intermediary is informed (at 108) that the applicant does not qualify for WPO funding. The applicant is not enrolled as a client of the funds provider. If the applicant is determined (at 106) to qualify for WPO funding, then the applicant or the intermediary is informed (at 110) that the applicant will be enrolled as a client of the funds provider, along with the maximum amount of WPO funding for which the applicant qualified.

Where the applicant has been approved for registration as a client of the funds provider, account opening information is requested (at 112) from the applicant or the intermediary. Account opening information includes any suitable information for commencing WPO funding for the applicant. In some embodiments, an account opening form is sent (e.g., electronically) to the applicant or intermediary. In other embodiments, the applicant or intermediary is directed to a website to submit the account opening information online.

The account opening information may include applicant information, applicant's banking information, and contact information. Applicant information may include the applicant's name, address, and registration/identification number. Banking information may include the name, the address, and the account number of the banking institution through which the applicant normally conducts banking transactions. Contact information may include the name of a primary contact and the contact information for the primary contact.

The account opening information may further include Internal Revenue Service (IRS) information, Inland Revenue information, or state or local government information (or other relevant governmental information), information on the applicant's directors, information on repaying the WPO funding, the number of workers to be paid, and signed authorizations. Information on the applicant's directors may include name and address. Information on repaying the WPO funding may include information on fees, charges, the payment date, and bank account information from which funds can be directly debited. Signed authorizations may include a signed authorization from the applicant allowing another entity (e.g., the funds provider) to provide WPO funds directly to the workers, and a signed warranty or guarantee from the applicant (and/or its director(s) and/or officer(s)) guaranteeing that the information supplied is correct and declaring to stop a fraudulent act from knowingly being committed. Other appropriate guarantees obtained from the applicant can warrant against incorrect information (e.g., misinformation, non-disclosure, etc.), and otherwise guarantee the repayment of funded amounts, and related fees and charges.

Account opening information is received (at 114) from the applicant. Once the account opening information is received and processed, the applicant becomes a client of the funds provider and is eligible for WPO funding up to the approved maximum funding or credit amount. The approved funding amount may be for a time unlimited or limited. In one embodiment, the approved funding amount is for an unlimited time until the risk measure for the applicant changes.

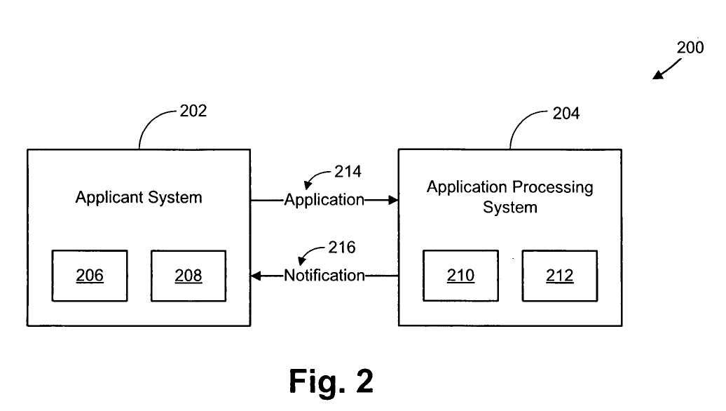

FIG. 2 is a block diagram illustrating one embodiment of a system 200 for applying for WPO funding. System 200 includes an applicant system 202 and an application processing system 204. Applicant system 202 includes a processor 206 and a memory 208. In one embodiment, applicant system 202 is a personal computer. Application processing system 204 is controlled by the funds provider and includes a processor 210 and a memory 212. In one embodiment, application processing system 204 is a server. In another embodiment, memory 212 includes software that, when executed by processor 210, performs method 100 of FIG. 1.

Applicant system 202 electronically communicates with application processing system 204. In one embodiment, applicant system 202 and application processing system 204 communicate via a network. Exemplary networks include a local area network (LAN) and the Internet.

The intermediary or the applicant transmits an application 214 for registration as a client of funds provider (and thus for WPO funding) from applicant system 202 to application processing system 204. Based on application 214, application processing system 204 determines a risk measure of the applicant. In one embodiment, the risk measure is determined by accessing a database (not shown) as described above. Application processing system 204 transmits a notification 216 to applicant system 202 based on the determined risk measure. Notification 216 informs the intermediary or applicant whether applicant is approved or denied for WPO funding. If applicant is approved for enrollment as a client of the funds provider, notification 216 further includes the amount of WPO funding for which the applicant is approved.

Once approved and enrolled, a client can submit (e.g., electronically) periodic request(s) to the funds provider for WPO payment to a worker or workers of the client. To facilitate these payment(s), the client submits to the funds provider information regarding the worker(s) for whom WPO payment is being (or will be) requested, along with the requested WPO payment amount(s). Details on these activities are provided below. In general terms, however, the funds provider can maintain a database of previously entered worker information from a particular client such that subsequent, periodic requests for WPO payment for that same worker need not require the client to re-submit some or all of the worker information; instead, only the requested funding amount is sent by the client to the funds provider for a worker previously processed by the funds provider on behalf of the client.

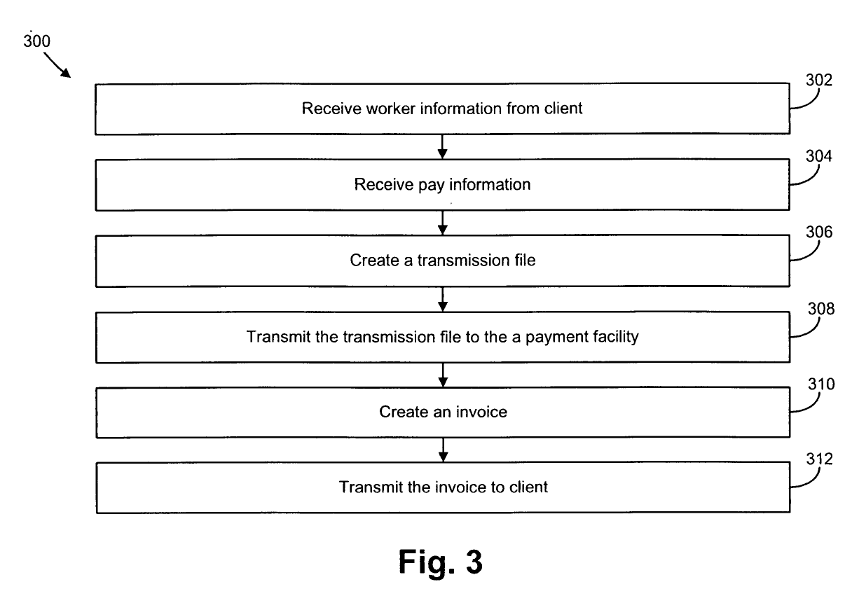

FIG. 3 is a flow diagram illustrating one embodiment of a method 300 of providing WPO funding. Worker information about the client's worker(s) subject to WPO funding by the funds provider is received (at 302) from the client. The worker information includes any suitable or necessary information for paying a requested WPO to the worker by a separate entity such as the funds provider, and thus may include names, social security numbers, and bank account information for direct deposit. The client can submit worker information for one, two, or a multiplicity of different workers. The worker information may be entered by the client through any suitable conduit, such as postal mail, telephone, and electronic transmission. In some embodiments, the worker information is submitted by the client to the funds provider through a website. The worker information entered through the website may be independently verified to ensure that each worker that is listed to be paid is entitled to be paid, thereby preventing any fraudulent and unearned payments.

Pay information regarding the client's worker(s) to receive WPO payment from the funds provider is received (at 304) from the client in connection with a WPO payment request. The pay information includes payment information, such as the wage, salary, or other renumeration of each worker covered by the WPO funding in accordance with a particular request from the client, along with applicable withholding and deductions as established by the client. The pay information can further include pay scheduling information, such as the payment date, specifying when payments are to be made. In some embodiments, the client submits pay information at given intervals. For example, if a worker is paid bi-weekly, then the client may submit pay information at bi-weekly intervals. Regardless, in other embodiments, the client submits a WPO payment request (including the corresponding pay information) to the funds provider through a website. As a point of reference, the client may submit identical WPO payment requests at regular intervals; can submit WPO payment requests at regular intervals but with differing amounts and/or identified worker(s); or can randomly submit WPO payment requests on an “as needed” basis that will thus vary from request-to-request. Where a regular WPO payment request protocol is established, the funds provider can maintain an electronic database of previous payment requests (or portions thereof, such as pay information), operating to automatically display or present previous request information to the client upon being notified that the client desires to submit a “new” payment request.

A transmission file is created (at 306) based on the submitted pay information. In some embodiments, the transmission file is a comma-separated values (CSV) file storing different pay information in different fields. For example, the CSV file may include a field for employee identification, a field for the gross wage amount, a field for the net wage to be paid to the worker, one or more fields for payment(s) to governmental organization(s), one or more fields for statutory or other deductions to be paid to a third party (or third parties), and a field for the date when the wage is paid. In other embodiments, any suitable file format can be used for storing the pay information.

The transmission file is transmitted (at 308) to a payment facility. The payment facility makes the requested WPO payment(s) to the client's workers (and other entity or entities as described above such as a governmental organization(s)) based on the transmission file. In one embodiment, the payment facility is a bank with which the funds provider has an account and/or line of credit. In another embodiment, the payment facility is an external payroll service with which the funds provider has a financial relationship. In yet other embodiments, the payment facility, for example the funds provider itself, is a local facility for directly transmitting funds to workers.

The payment facility pays the WPO payment(s) on behalf of the client. In some embodiments, the payment facility directly deposits a wage into the worker's (or workers') bank account(s). In other embodiments, the payment facility issues a paycheck to the worker(s), payment to a preloaded debit card, etc. In yet other embodiments, the payment facility pays any applicable governmental withholdings and deductions. For example, the payment facility may pay taxes and/or other withholdings directly to the IRS, Inland Revenue, state or local government, or other governmental organization. Where desired, the funds provider can optionally obtain credit insurance for amounts advanced to/on behalf of the client (e.g., 90% of the total value).

An invoice is created (at 310) by the funds provider for the client relating to the WPO transaction (paid by the funds provider in response to the client's submitted request). The invoice is transmitted (at 312) to the client. The invoice includes information regarding terms by which the client will repay the funds provider for the funding provided in satisfying the WPO payment(s) on the client's behalf, along with other charges or fees required by the funds provider. The invoice may include any suitable information, such as the amount of funding provided and the date the funds were paid out. The invoice may further include any suitable information regarding the client's repayment of the WPO funding.

The generated invoice is delivered to the client (e.g., electronically), and includes agreed upon terms for repayment. The agreed upon terms will include a fixed period (e.g., two weeks, one month, etc.) by which repayment must be received. Optionally, the funds provider can sell or “factor” the invoice to a third party. Regardless, the client can repay the invoice in various acceptable manners, such as by check, preloaded direct debit, chaps (electronic, bank-to-bank same-day valve payment), etc. In some embodiments, the funds provider charges a fee for use of the funding services, for example a percentage of the total amount paid by the funds provider in meeting the client's requested WPO payments, and/or a percentage of the client's average monthly balance with the funds provider, etc. The charge(s) or fee(s) are included in the invoice.

While an invoice can be issued by the funds provided immediately after processing a WPO request, in some embodiments the methods of the present disclosure entail the invoice covering two (or more) WPO payment requests received within a set time period. For example, and assuming a client's maximum approved credit limit is not exceeded, the funds provider can generate a single invoice for all requested WPO payment transactions received over the course of one month.

Along these same lines, the methodologies of the present disclosure can provide the client with a revolving request feature whereby as soon as a repayment is received from the client, the repayment amount is applied to the client's current balance with the funds provider and is available to the client for future WPO payment requests. By way of non-limiting example, a client can be approved for a maximum limit of $1,000.00. Following a WPO payment request for $400.00, the funding balance available to the client would be $600.00. Under circumstances where the funds provider receives a $200.00 repayment from the client, the funding balance available to the client for a future WPO payment request will now be $800.00. Regardless of exact amounts, the revolving availability of repaid amounts can occur on a continual basis.

In some embodiments, the revolving availability or “re-use” of repaid amounts can be utilized by a client for multiple payment cycles in meeting the client's WPO obligations. For example, for a client having weekly WPO obligations, the funds provider will pay (or oversee payment of) the client's WPO requests, beginning in Week 1. Assuming the client's maximum available credit amount is not exceeded, the funds provider will pay WPOs for Weeks 2-8 (including, where applicable, governmental obligations). Assuming further that the client's available credit amount is reached following payment by the funds provider of the Week 8 WPO request, the funds provider would not make any further payments on the client's behalf. However, if a partial repayment is received from the client in Week 8 that repay the funds provider's payment from only Week 1, this repayment amount is applied to the client's balance, and the funds provider will pay the client's requested WPOs in Week 9 (assuming that the newly calculated available balance is sufficient). If the Week 2 repayment is received from the client in Week 9, the funds provider will pay the client's requested WPOs in Week 10 (again, assuming that the newly calculated available balance is sufficient), etc. The amounts and repayment period(s) can be selected as desired by the funds provider. For example, the repayment cycle can be implemented on a monthly basis.

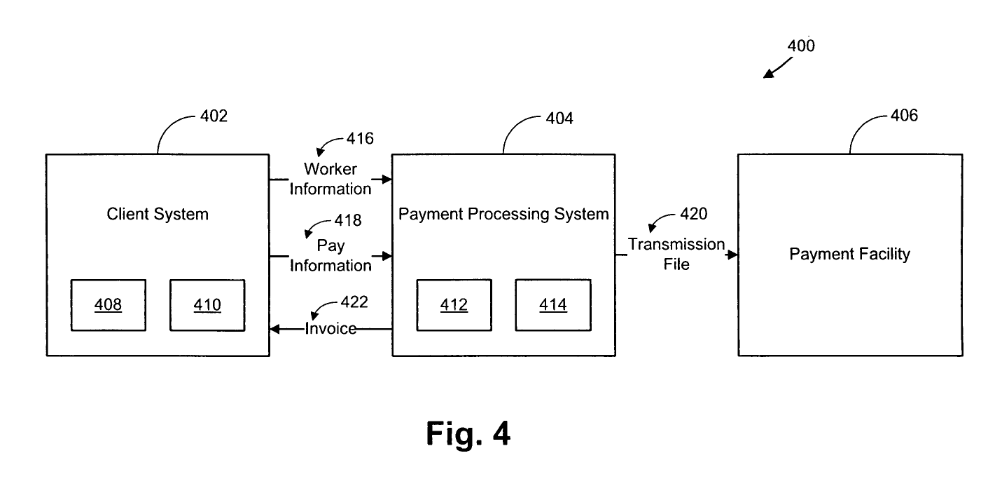

FIG. 4 is a block diagram illustrating one embodiment of a system 400 for providing WPO funding. System 400 includes a client system 402, a payment processing system 404, and a payment facility 406. Client system 402 includes a processor 408 and a memory 410. In some embodiments, client system 402 is a personal computer. Payment processing system 404 is controlled by the funds provider, and includes a processor 412 and a memory 414. In some embodiments, payment processing system 404 is a server. In other embodiments, memory 414 includes software that, when executed by processor 412, performs method 300 of FIG. 3.

Client system 402 communicates with payment processing system 404, which communicates with payment facility 406. In one embodiment, client system 402, payment processing 404, and payment facility 406 communicate via a network.

Client submission system 402 transmits worker information 416 and pay information 418 to payment processing system 404. In one embodiment, worker information 416 and WPO pay information 418 are submitted by a client through a website.

Payment processing system 404 creates a transmission file 420 based on worker information 416 and WPO pay information 418. Transmission file 420 is transmitted to payment facility 406. Payment processing system 404 also creates an invoice 422, which is transmitted to client processing system 402.

Information input through an online form may be verified locally to ensure that data input by the client is correctly formatted. For example verification may be performed to ensure that alphanumeric characters input for an email address follow the convention for email addresses. Information input through the online form may also be verified externally to ensure that data input by the client is correct. For example, bank account data and worker data may be verified by the bank to ensure that the correct bank account is correctly associated with a particular worker.

As indicated above, the application, WPO payment request, and invoicing are performed electronically in accordance with aspects of the present disclosure, for example via the internet (e.g., World Wide Web). The following description provides an explanation of but some acceptable manners in which electronic WPO transactions can occur, along with representations of possible interfaces (e.g., screenshots or displays) generated by the funds provider's computer server and as viewed by, and interacted with, an applicant or client.

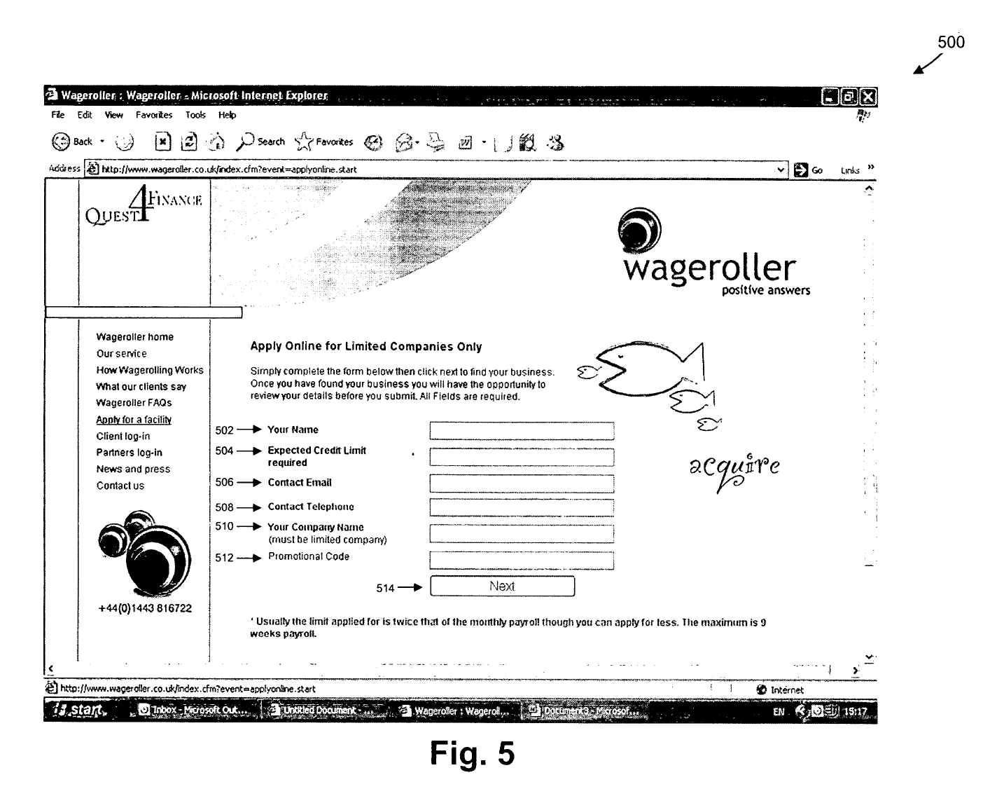

FIG. 5 is a screenshot illustrating one example of an online application screen 500. Online application screen 500 includes a name field 502, an expected or desired credit limit field 504, a contact email field 506, a contact telephone field 508, a company name field 510, and a promotional code field 512.

One or more of fields 502-512 are completed by the applicant. A “next” icon button 514 is selected (e.g., a cursor or similar computer user interaction icon placed over the “next” icon and a keyboard key or mouse button depressed) to electronically submit fields 502-512 to the funds provider. As a point of reference, use of the word “button” in the following description is in the context of conventional computer interactions with a display screen or website in which an icon is displayed in a format having the appearance of a button, and when selected or “clicked,” automatically causes a operation of a pre-determined program (e.g., linking to a new page, electronically sending information, etc.).

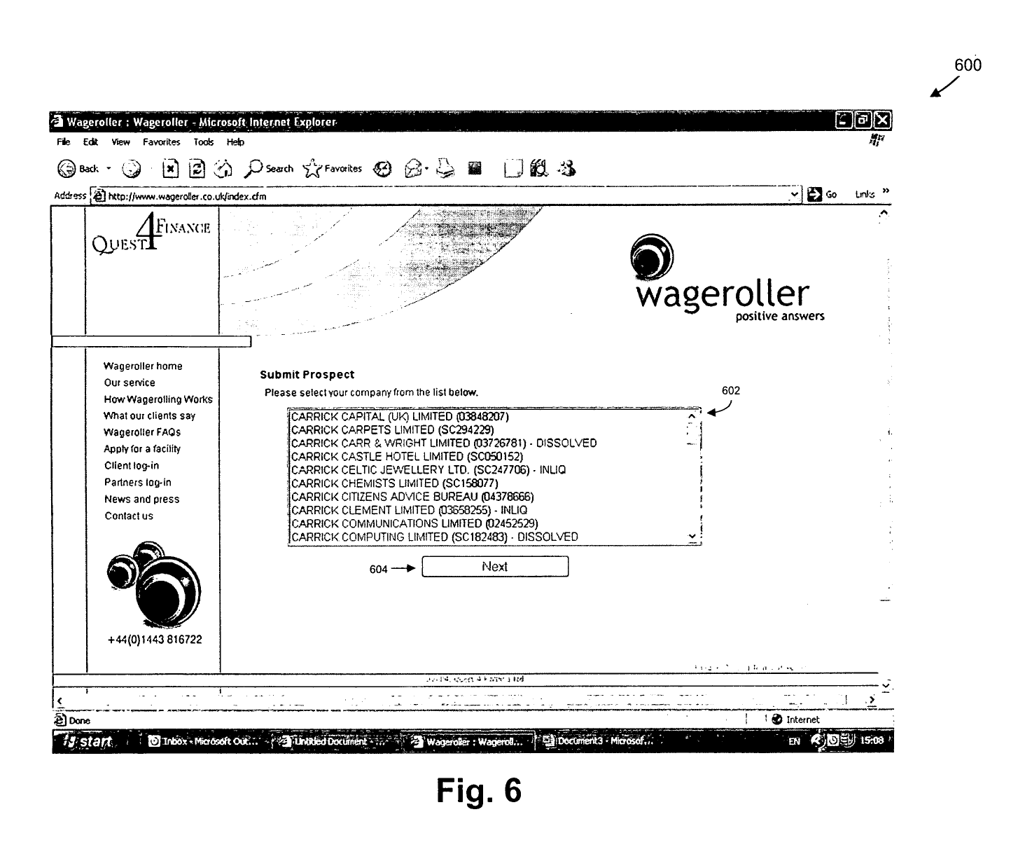

FIG. 6 is a screenshot illustrating one example of a company (or applicant) selection screen 600. Company selection screen 600 includes a company list 602 including a plurality of company names and associated registration numbers from a listing maintained or accessed by the funds provider. In one embodiment, company selection screen 600 automatically follows (e.g., is automatically displayed) online application screen 500 (FIG. 5) after next button 514 (FIG. 5) is selected. In another embodiment, the plurality of company names displayed on company list 602 are alphabetically chosen based on company name field 510.

One of the company names and associated registration numbers is selected by the applicant. A next button 604 is selected to submit the selected company name to the funds provider.

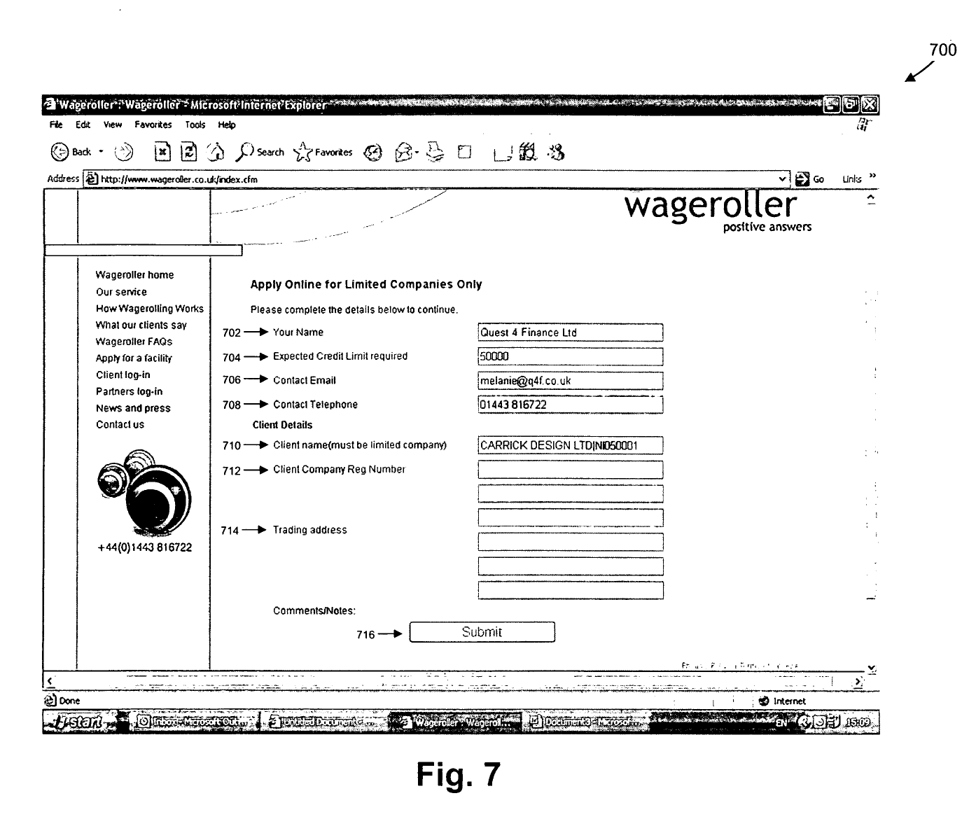

FIG. 7 is a screenshot illustrating one example of a company address screen 700. Company address screen 700 includes a name field 702, an expected credit limit field 704, a contact email field 706, a contact telephone field 708, a client name field 710, a client registration number field 712, and an address field 714. In one embodiment, company address screen 700 automatically follows company selection screen 600 after next button 604 is selected. In another embodiment, name field 702, expected credit limit field 704, contact email field 706, and contact telephone field 708 are automatically completed based on the submissions provided for name field 502, expected credit limit field 504, contact email field 506, and contact telephone field 508, respectively. In another embodiment, client name field 710 and client registration number field 712 are automatically completed based on the company name and associated registration number selected from company list 602.

One or more of fields 702-714 are completed by the applicant. A next button 716 is selected to submit fields 702-714 to the funds provider.

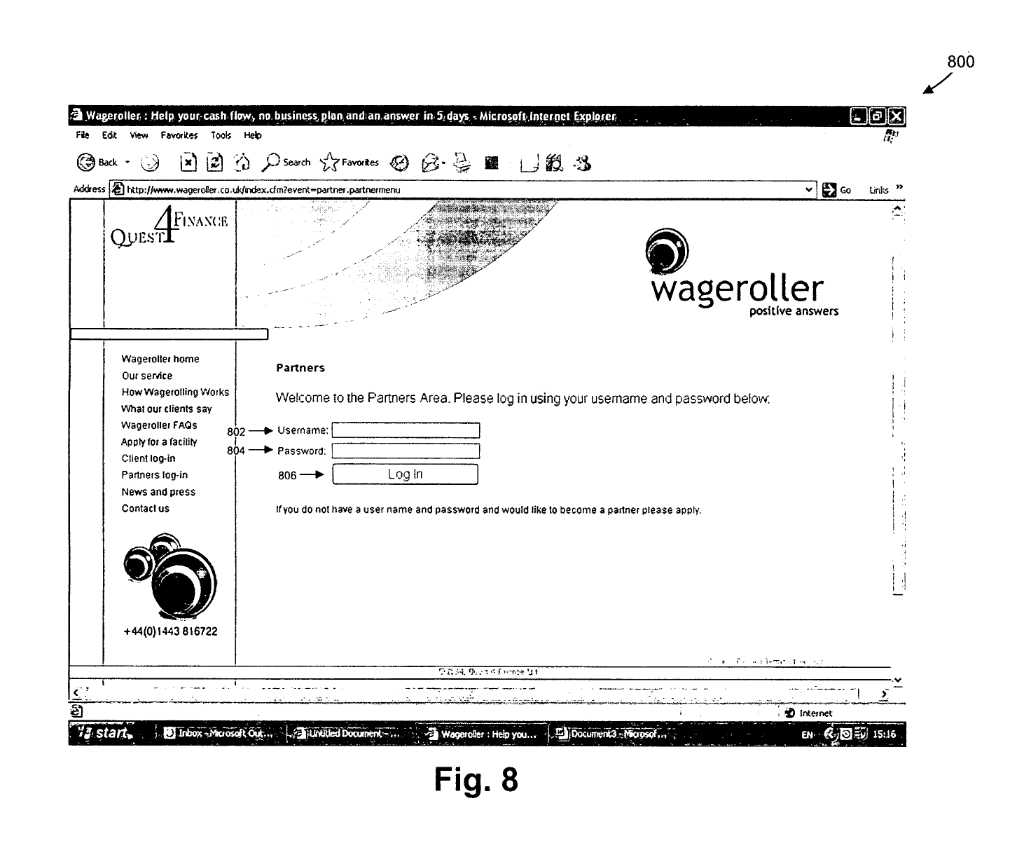

FIG. 8 is a screenshot illustrating one example of a broker login screen 800. Broker login screen 800 includes a username field 802 and a password field 804. Username field 802 and password field 804 are completed. A login button 806 is selected to submit username field 802 and password field 804 to the funds provider.

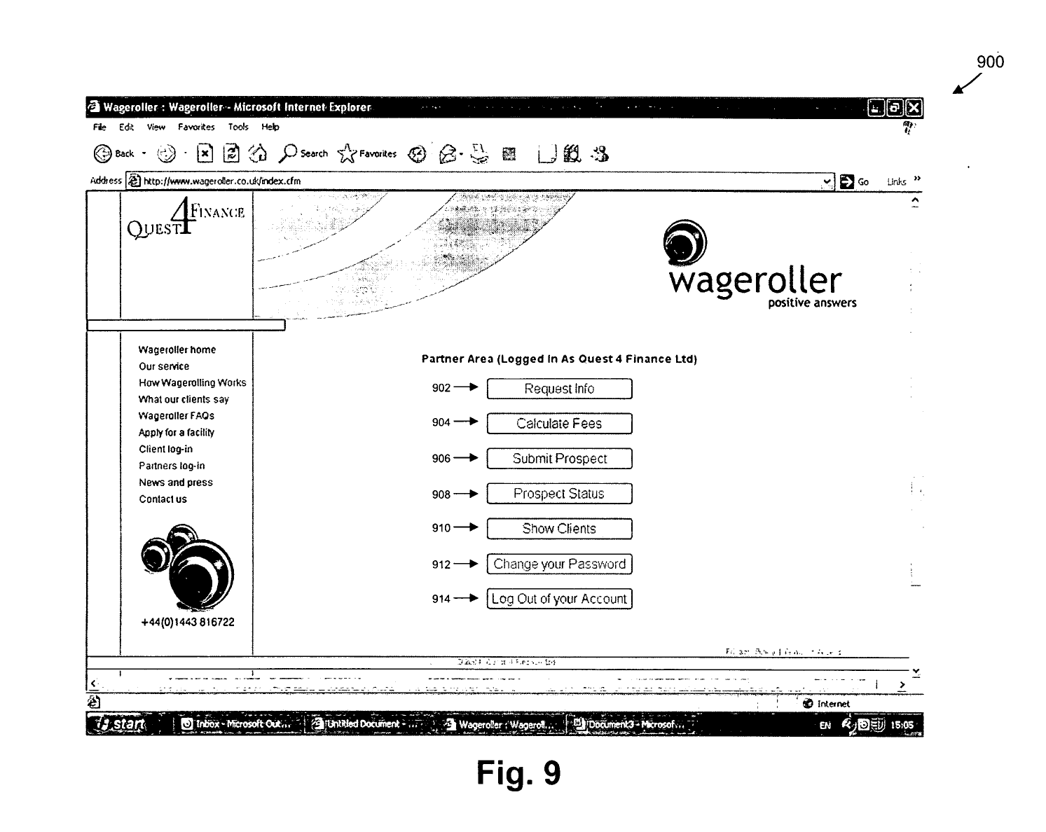

FIG. 9 is a screenshot illustrating one example of a broker area screen 900. Broker area screen 900 includes a request info button 902, a calculate fees button 904, a submit prospect button 906, a prospect status button 908, a show clients button 910, a change password button 912, and a logout button 914. In one embodiment, broker area screen 900 automatically follows broker login screen 800 after login button 806 is selected. One of buttons 902-914 is selected and the corresponding information submitted to the funds provider.

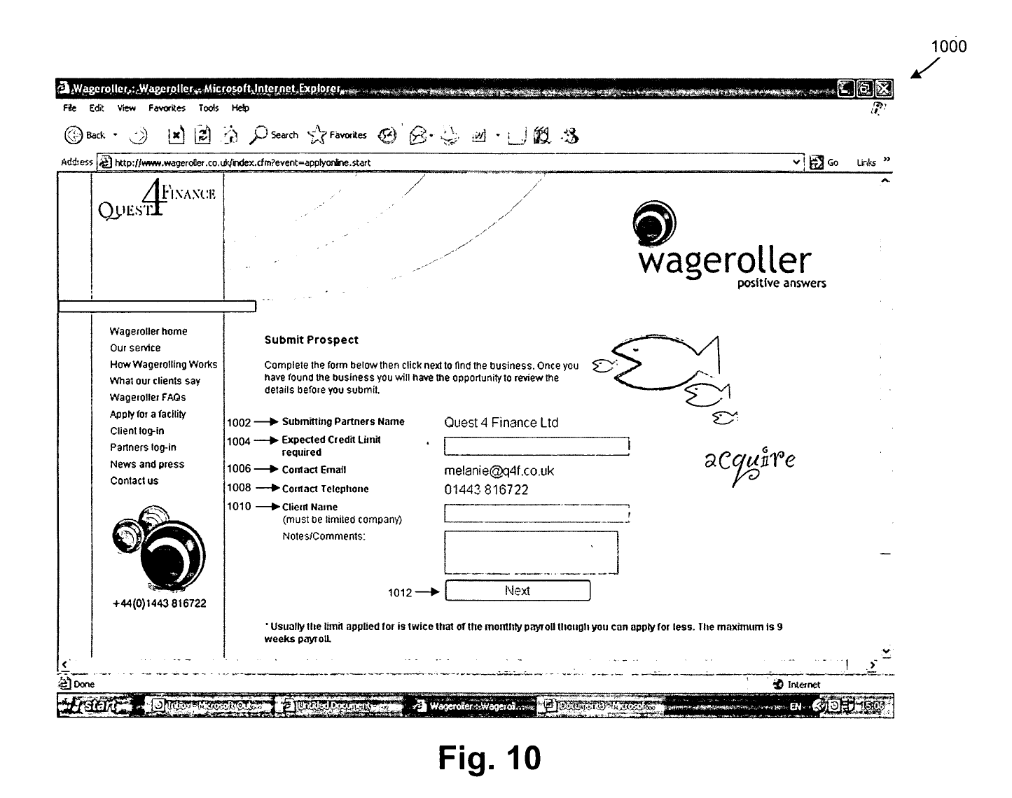

FIG. 10 is a screenshot illustrating one example of a submit prospect screen 1000. Submit prospect screen 1000 includes a broker name field 1002, an expected credit limit field 1004, a contact email field 1006, a contact telephone field 1008, and a client name field 1010. In one embodiment, submit prospect screen 1000 automatically follows broker area screen 900 after submit prospect button 906 is selected. In another embodiment, broker name field 1002, contact email field 1006, and contact telephone field 1008 are automatically completed based on the submitted username field 802.

One or more of fields 1002-1010 are completed. A next button 1012 is selected to submit fields 1002-1010 to the funds provider. In one embodiment, company selection screen 600 follows submit prospect screen 1000 after next button 1012 is selected. Company address screen 700 may automatically follow company selection screen 600.

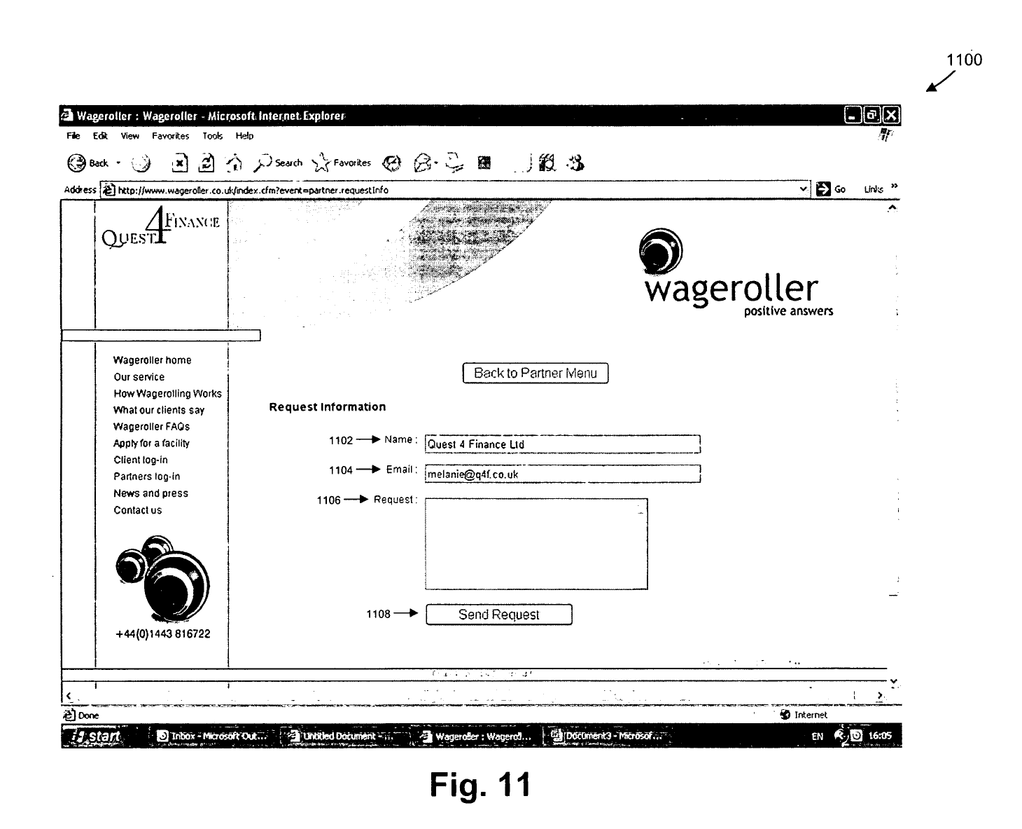

FIG. 11 is a screenshot illustrating one example of a request info screen 1100. Request info screen 1100 includes a name field 1102, an email field 1104, and a request field 1106. In one embodiment, request info screen 1100 automatically follows broker area screen 900 after request info button 902 is selected. One or more of fields 1102-1106 are completed. A send request button 1108 then is selected to submit fields 1102-1106 to the funds provider.

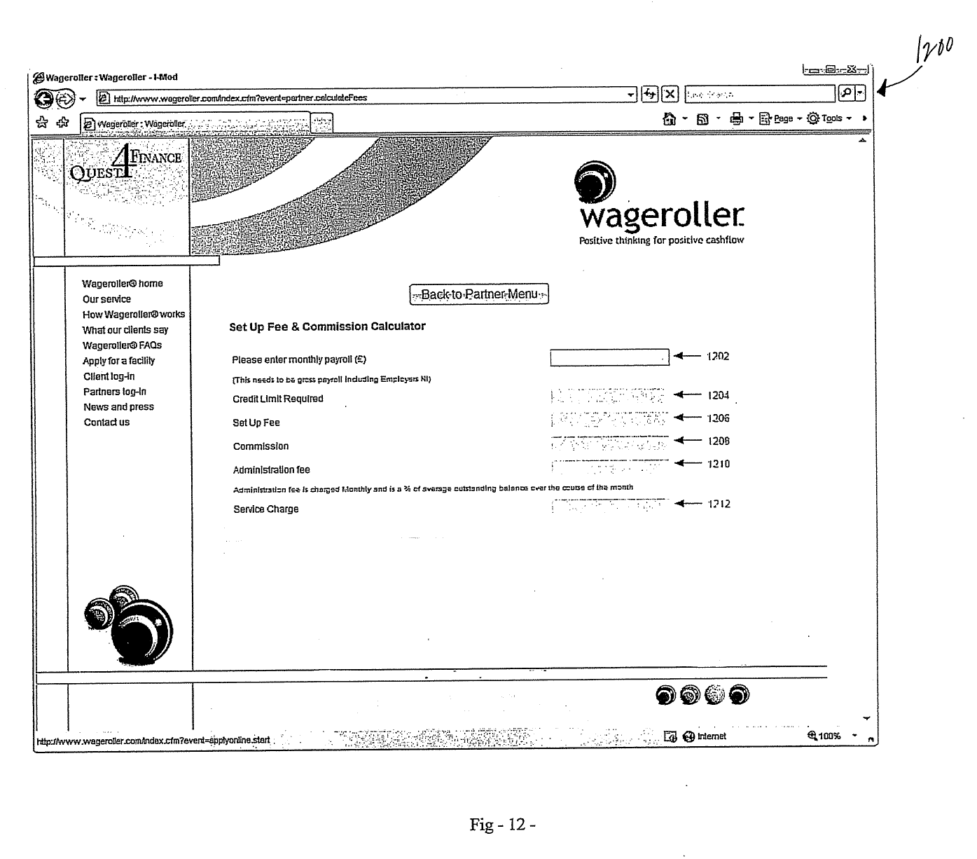

FIG. 12 is a screenshot illustrating one example of a calculate fees screen 1200. Calculate fees screen 1200 enables a broker to establish with the funds provider any applicable fees, such as setup fee, a commission, an administration fee, and a service charge. Calculate fees screen 1200 also enables the broker to set up how a potential client is to pay the fees. Calculate fees screen 1200 includes a monthly payroll field 1202, a credit limit field 1204, a setup fee field 1206, a commission field 1208, an administration fee field 1210, and a service charge field 1212.

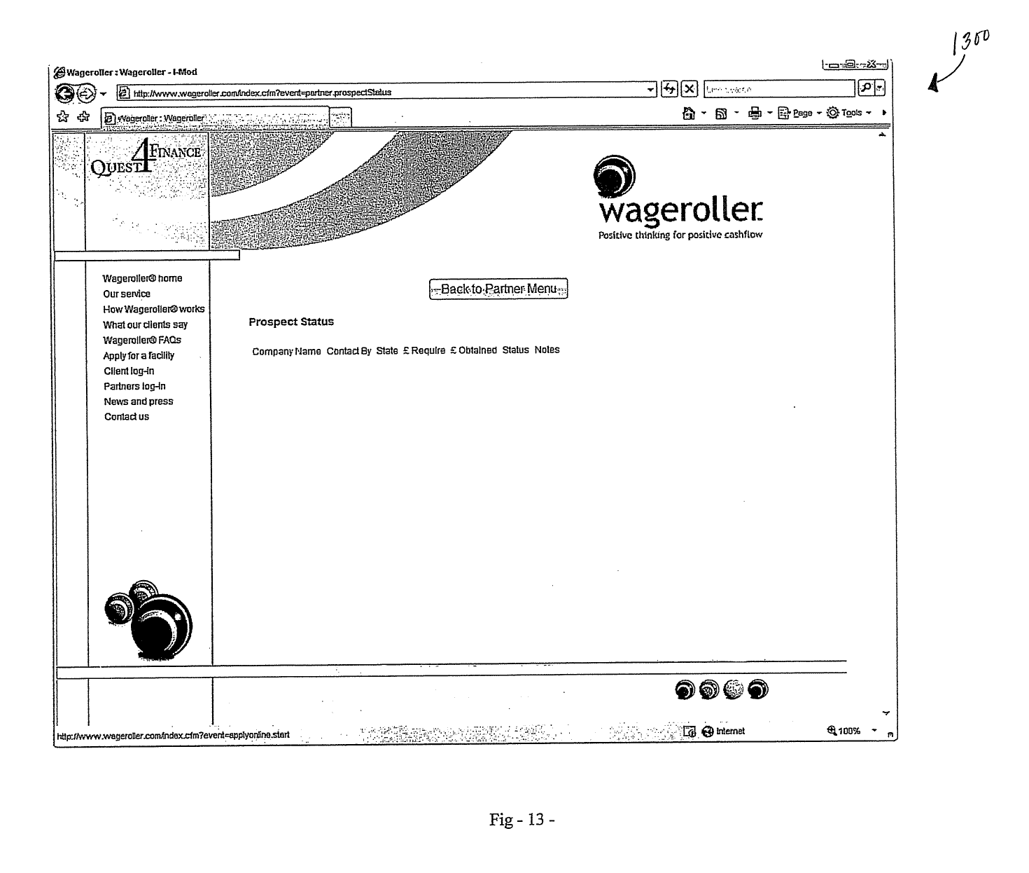

FIG. 13 is a screenshot illustrating one example of a prospect status screen 1300. Prospect status screen enables a broker to track any submitted prospects and their application status. In one embodiment, prospect status screen 1300 automatically follows broker area screen 900 after prospect status button 908 is selected.

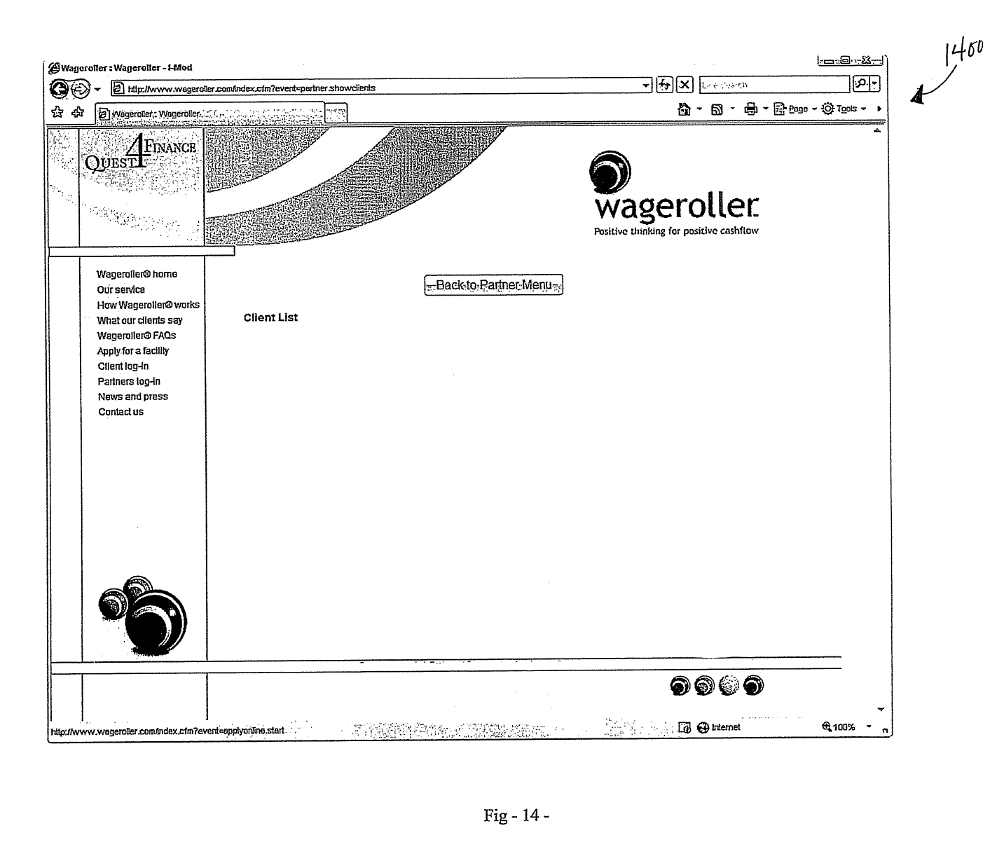

FIG. 14 is a screenshot illustrating one example of a client list screen 1400. Client list screen 1400 enables a broker to view a list of all clients attributable to the particular broker. In one embodiment, client list screen 1400 automatically follows broker area screen 900 after show clients button 910 is selected.

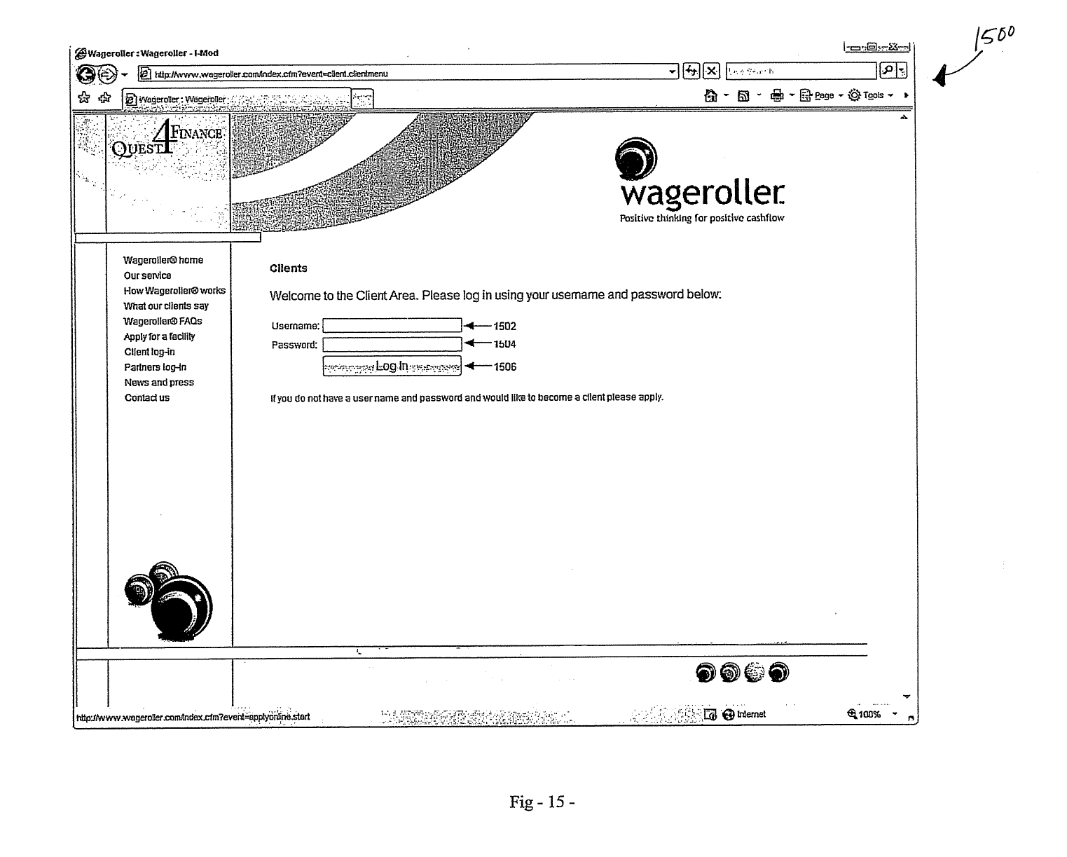

Once established as a client, the client can electronically interface with the funds provider in performing various operations. FIG. 15 is a screenshot illustrating one example of a client login screen 1500. Client login screen 1500 includes a username field 1502 and a password field 1504. Username field 1502 and password field 1504 are completed. A “login” button (or icon) 1506 is selected to submit username field 1502 and password field 1504 to the funds provider.

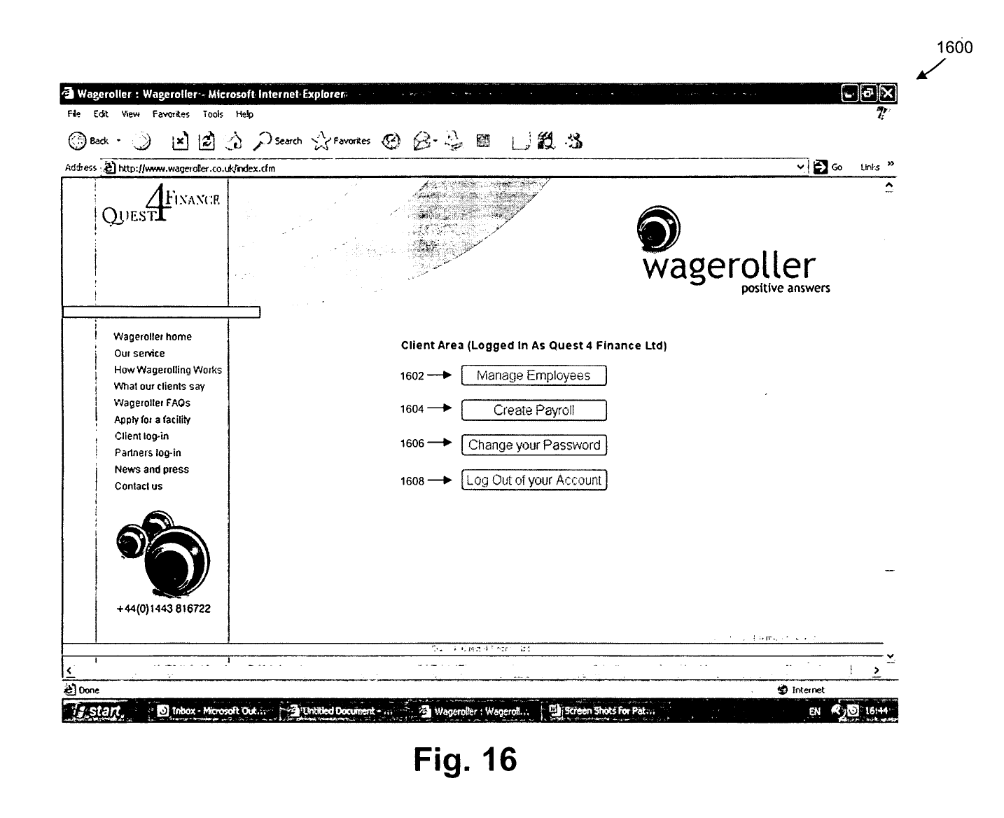

FIG. 16 is a screenshot illustrating one example of a client area screen 1600. Client area screen 1600 includes a manage employees button 1602, a create payroll button 1604, a change password button 1606, and a logout button 1608. In one embodiment, client area screen 1600 automatically follows client login screen 1500 after login button 1506 is selected. The client indicates a desired client operation by selecting the corresponding button 1602-1608.

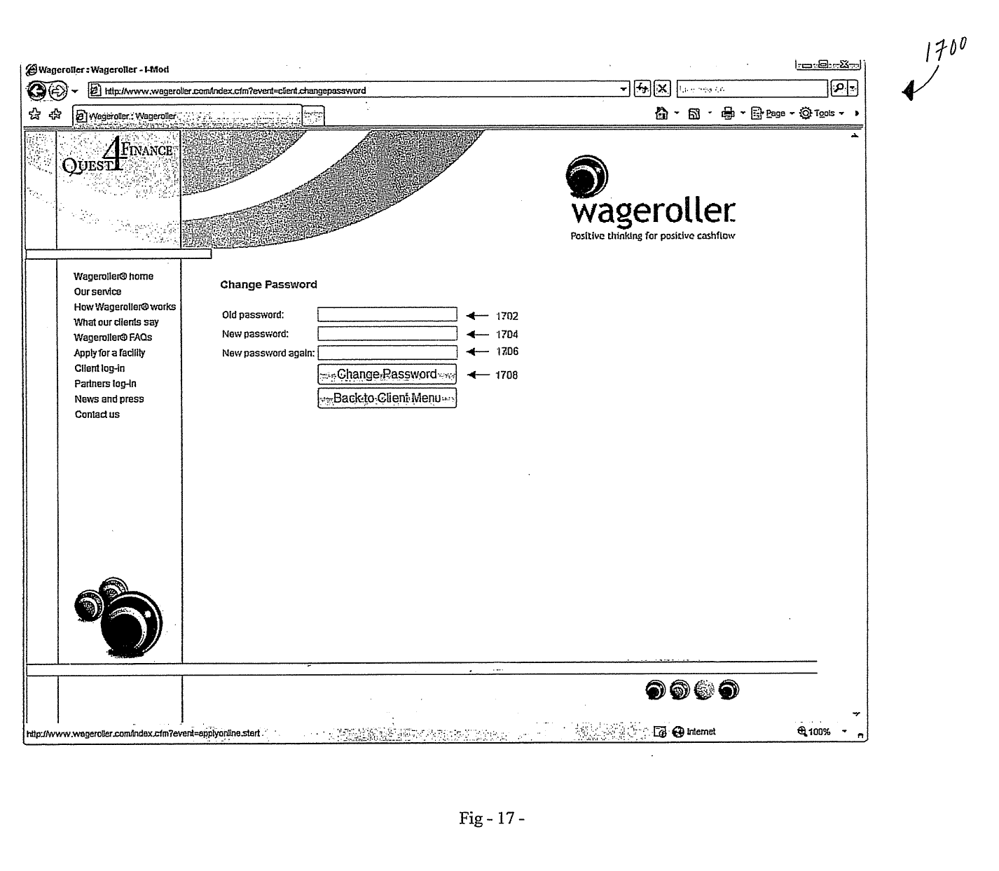

FIG. 17 is a screenshot illustrating one example of a change password screen 1700. Change password screen 1700 enables a broker or a client to change the login password. Change password screen 1700 includes an old password field 1702, a new password field 1704, and a new password again field 1706. In one embodiment, change password screen 1700 automatically follows broker area screen 900 after change password button 912 is selected. In another embodiment, change password screen 1700 automatically follows client area screen 1600 after change password button 1606 is selected.

Where a password change is desired, old password field 1702, new password field 1704, and new password again field 1706 are completed. Change password submit button 1708 is then selected to submit old password field 1702, new password field 1704, and new password again field 1706 to the funds provider.

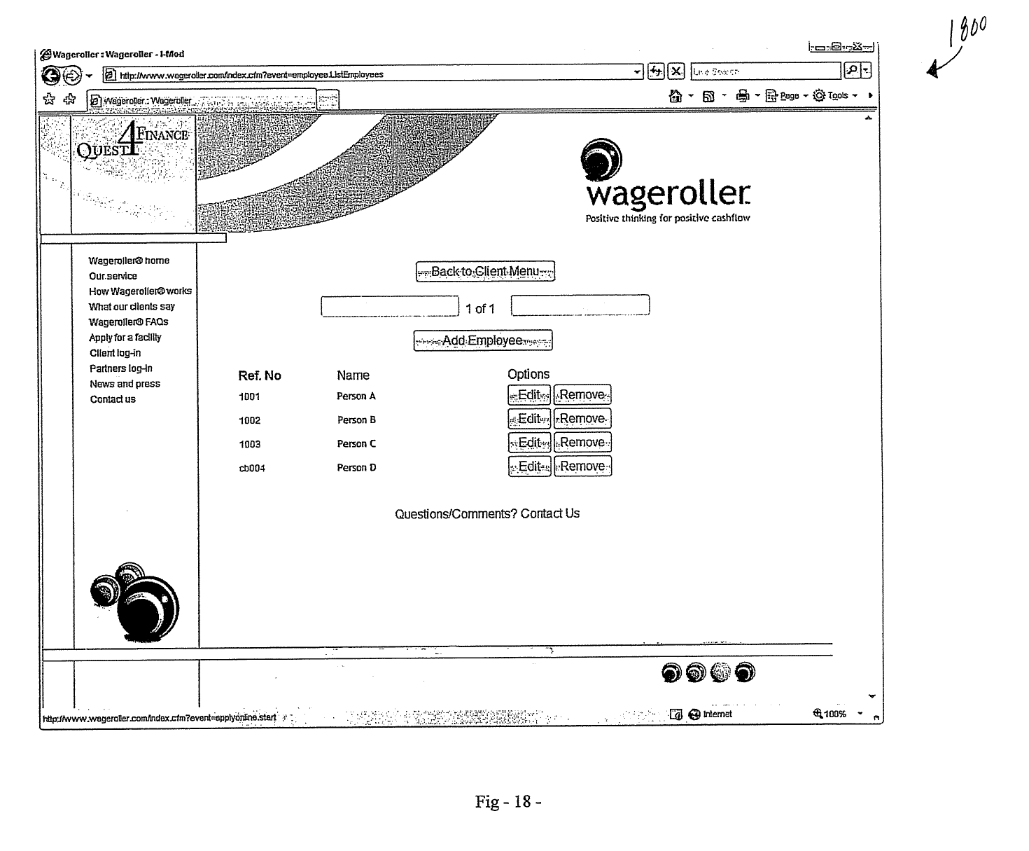

FIG. 18 is a screenshot illustrating one example of a manage employees screen 1800. Manage employees screen 1800 enables a client to add new worker information details, such as personal and bank account information, and/or to edit existing worker information details. In one embodiment, manage employees screen 1800 automatically follows client area screen 1600 after manage employees button 1602 is selected.

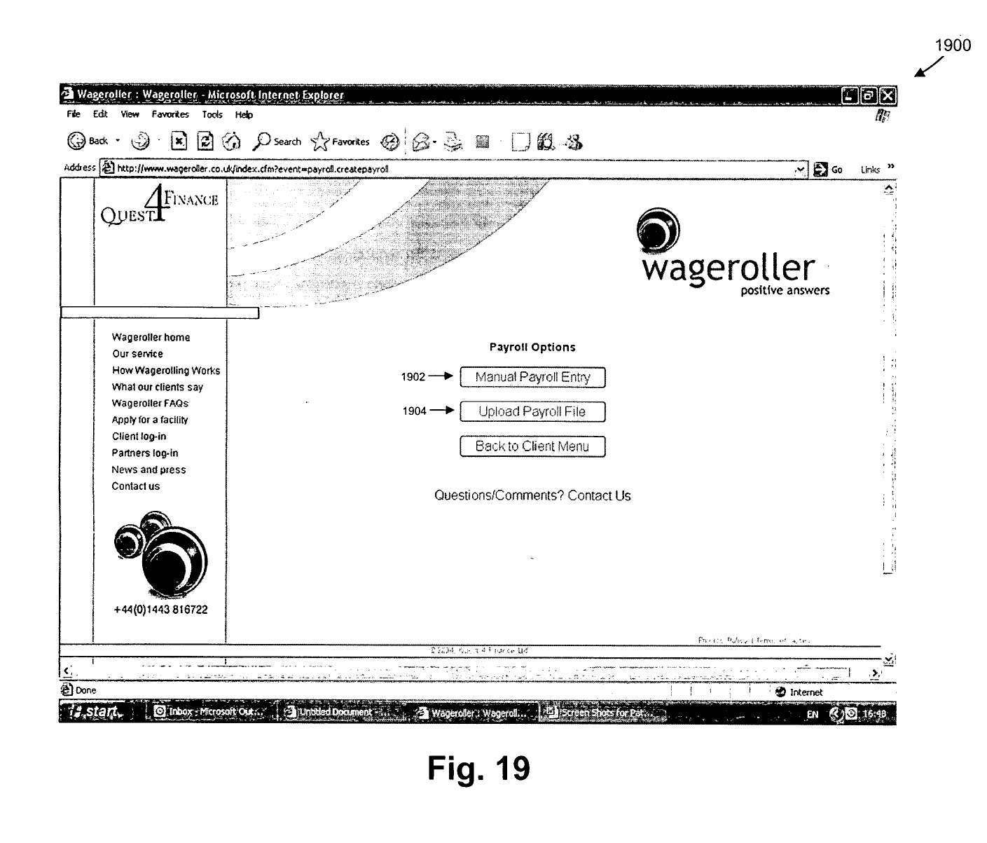

FIG. 19 is a screenshot illustrating one example of a create payroll screen 1900. Create payroll screen 1900 includes a manual payroll entry button 1902 and an upload payroll file button 1904. In one embodiment, create payroll screen 1900 automatically follows client area screen 1600 after create payroll button 1604 is selected. One of manual payroll entry button 1902 and upload payroll file button 1904 is selected by the client in accordance with an activity desired by the client.

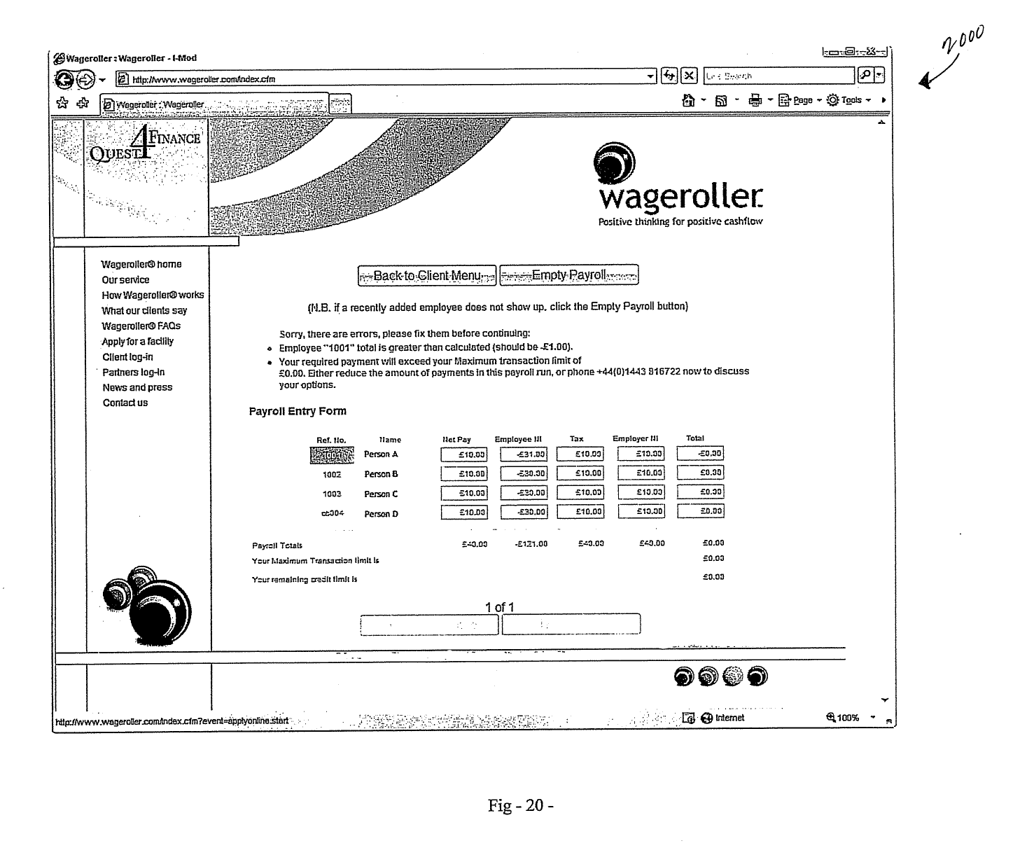

FIG. 20 is a screenshot illustrating one example of a manual payroll entry screen 2000. Manual payroll entry screen 2000 enables a client to manually enter payroll entries for each worker (or employee). In one embodiment, manual payroll entry screen 2000 automatically follows create payroll screen 1900 after manual payroll entry button 1902 is selected.

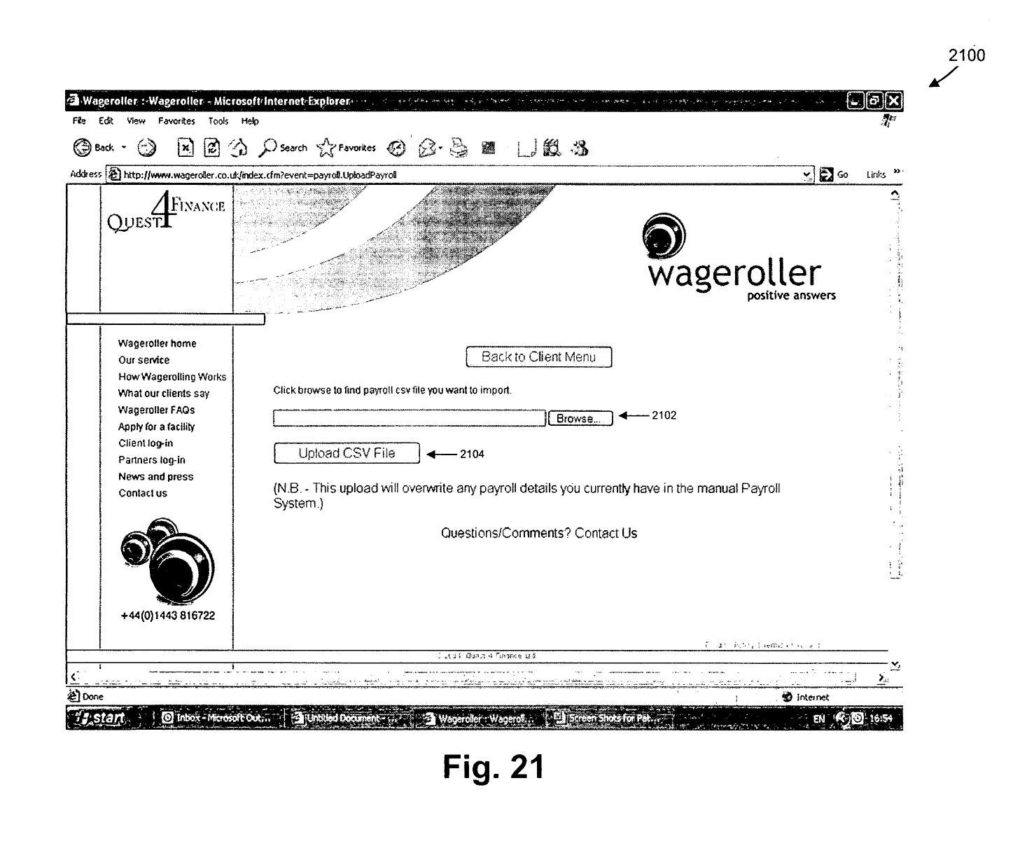

FIG. 21 is a screenshot illustrating one example of an upload payroll file screen 2100. Upload payroll file screen 2100 enables a client to upload a file containing payroll entries for each worker (or employee). Upload payroll file screen 2100 includes a browse button 2102 and an upload file button 2104. In one embodiment, upload payroll file screen 2100 automatically follows create payroll screen 1900 after upload payroll file button 1904 is selected.

A file is selected using the browse button 2102. Upload file button 2104 is then selected to submit the selected file to the funds provider.

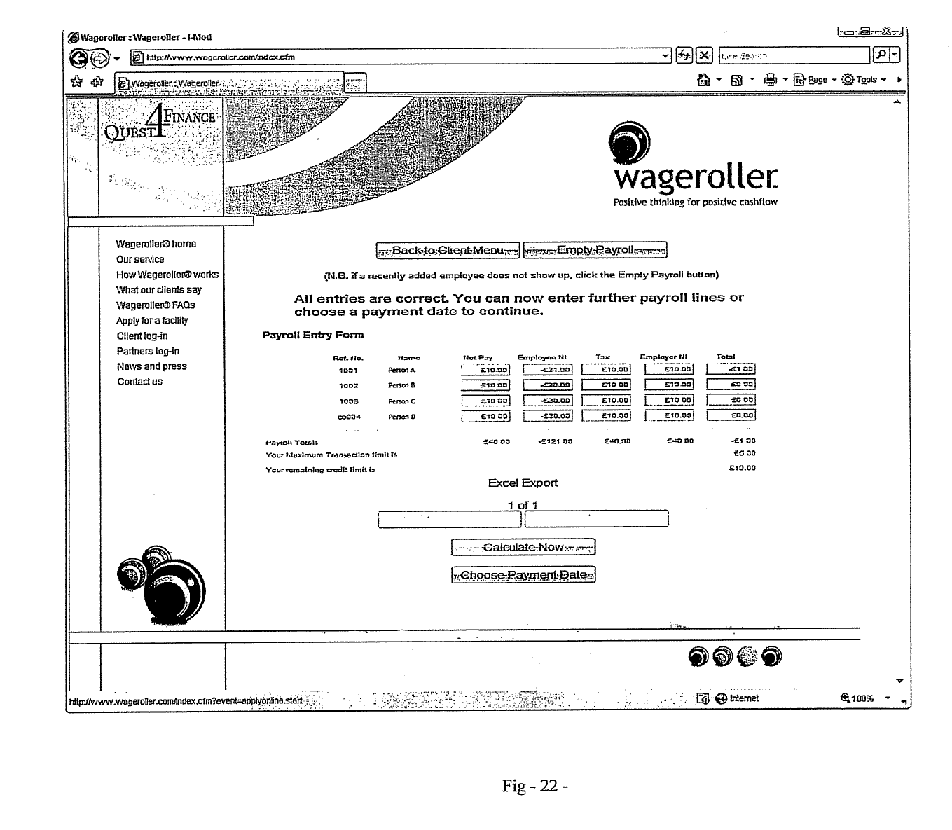

As indicated above, the funds provider will have an established maximum credit amount with each client. In some embodiments, the electronic interface generated by the funds provider to the client provides a distinct warning when a requested WPO funding will exceed the client's maximum available credit amount, and the client is provided with options for addressing the situation. For example, FIG. 22 is a screenshot illustrating one example of WPO payment request submitted by a client and approved by the funds provider. Amounts to be paid in meeting the WPO of each worker are shown, along with the client's balance relative to the client's credit limit following the transaction.

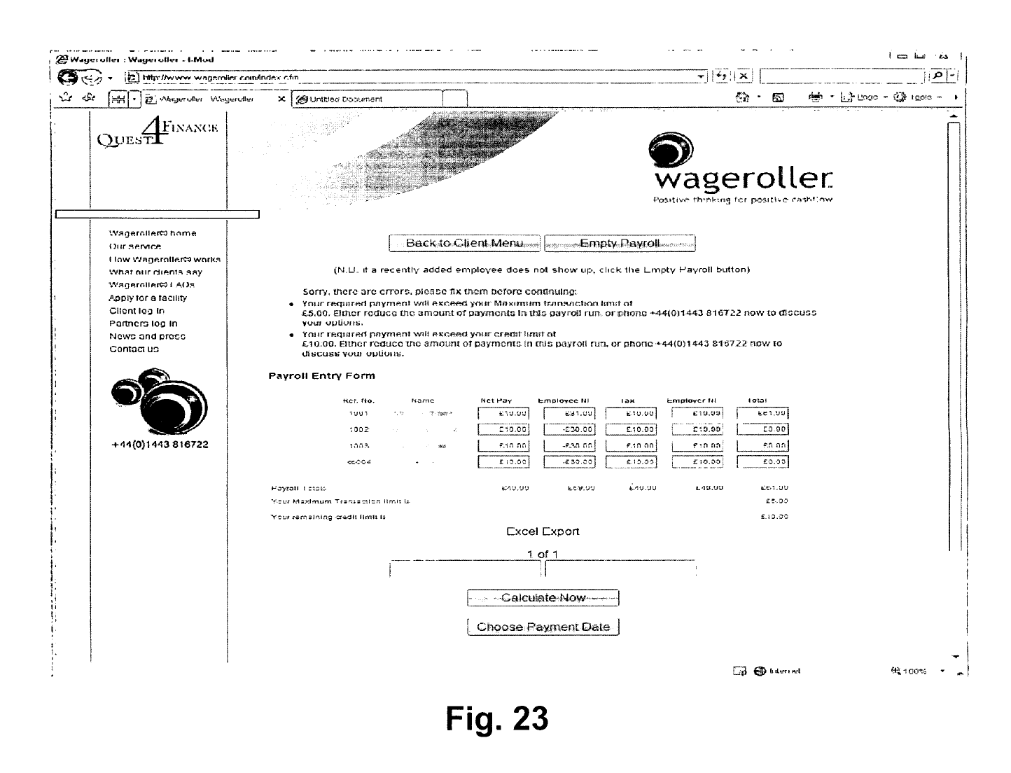

In contrast, FIG. 23 is a screenshot illustrating one example of a WPO payment request submitted by a client and denied by the funds provider for exceeding the client's maximum credit amount. Once again, amounts requested to be paid in meeting the WPO of each worker (as entered by the client) are shown. In addition, a written warning/explanation is given that none of the requested transactions will be made due to an insufficient available credit balance. In response, the client may re-submit the WPO funding request by eliminating and/or reducing the payment requested for one or more of the workers in an amount sufficient to not exceed the client's available credit balance.

Embodiments described and illustrated with reference to the Figures provide. It is to be understood that not all components and/or steps described and illustrated with reference to the Figures are required for all embodiments. In one embodiment, one or more of the illustrative methods are preferably implemented as an application comprising program instructions that are tangibly embodied on one or more program storage devices (e.g., hard disk, magnetic floppy disk, RAM, ROM, CD ROM, etc.) and executable by any device or machine comprising suitable architecture, such as a general purpose digital computer having a processor, memory, and input/output interfaces. An integrated management/accounting system and method can be provided in which a management system electronically monitors accounts and credit limits for multiple clients, ensuring that monies coming in are applied in a timely fashion and that once a WPO is put on the front end system by the client, it is processed and delivered to the designated worker(s) account(s). The back end management system is run and attaches to its banking and credit vetting systems. It manages the collection and issuing of money, thereby keeping the client's available credit balance updated, and generates agreed upon charges at the end of each invoice period.

Although specific embodiments have been illustrated and described herein, it will be appreciated by those of ordinary skill in the art that a variety of alternate and/or equivalent implementations may be substituted for the specific embodiments shown and described without departing from the scope of the present disclosure. This application is intended to cover any adaptations or variations of the specific embodiments discussed herein. Therefore, it is intended that this disclosure be limited only by the claims and the equivalents thereof.

What is claimed is:

1. A method of providing funding from a funds provider to at least one worker of a client, comprising:
receiving, by the funds provider from the client, worker information identifying at least one worker of the client;
receiving, by the funds provider from the client, pay information regarding the at least one worker;
requesting payment by the funds provider of a worker payment obligation (WPO) owed by the client to the at least one worker;
paying the WPO by the funds provider in accordance with the requested payment;
creating an invoice from the funds provider to the client regarding the payment made by the funds provider on behalf of the client; and
transmitting the invoice to the client.

2. The method of claim 1, wherein paying the WPO according to the pay information comprises:
creating a transmission file based on the worker information and the pay information; and
transmitting the transmission file to a payment facility.

3. The method of claim 2, wherein the transmission file is a comma-separated values (CSV) file.

4. The method of claim 1, further comprising:
establishing a fixed time period within which the client must submit repayment to the funds provider for a monetary amount owed reflected in the invoice.

5. The method of claim 4, further comprising:
establishing, by the funds provider, of a maximum credit limit for the client.

6. The method of claim 5, further comprising:
applying a payment received from the client to an available credit balance of the client for use in evaluating approval by the funds provider of a subsequent request for payment by the client to the funds provider.

7. The method of claim 6, wherein payments received by the funds provider from the client are continuously applied to the available credit balance on a revolving basis.

8. The method of claim 1, wherein requesting payment includes the client simultaneously requesting WPO payments for a multiplicity of workers of the client.

9. The method of claim 1, wherein requesting payment includes the client submitting to the funds provider a withholding amount remittable to a governmental organization as part of the WPO.

10. The method of claim 9, further comprising the funds provider submitting to the governmental organization the withholding amount on behalf of the client.

11. The method of claim 1, wherein the steps of receiving worker information, receiving pay information, and requesting payment are all performed by electronic communication between the client and the funds provider.

12. The method of claim 1, wherein the funds provider pays the WPO prior to receiving direct access to funds of the client.

13. The method of claim 1, further including the funds provider providing funding in accordance with claim 1 for a multiplicity of clients.

14. The method of claim 1, further comprising:
determining a service fee charged by the funds provider to the client for paying the WPO on the client's behalf,
wherein the invoice includes the calculated service fee.

15. The method of claim 14, wherein the service fee is determined as a function of an amount owed by the client to the funds provider at an end of a predetermined time period.

16. The method of claim 1, further comprising:
receiving application information from an applicant applying to be enrolled as a client of the funds provider;
reviewing the application information by the funds provider to determine whether the applicant is approved for enrollment as a client, including determining a maximum credit amount assigned to the applicant if approved as a client; and
informing the applicant of the client approval determination and the determined maximum credit amount.

17. The method of claim 1, wherein the WPO is a payroll obligation of an employer to an employee.

18. An electronic funding system for providing funds from a funds provider to at least one worker of a client of the funds provider, comprising:
a computer server controlled by the funds provider and associated with a website of the funds provider, the computer server programmed to process information of a client via the client electronically interfacing with the funds provider's website over a computer network, including:
receive worker information from the client identifying at least one worker of the client,
receive pay information from the client regarding the at least one worker,
process a request for payment from the client of a worker payment obligation (WPO) owed by the client to the worker,
facilitate payment of the WPO by the funds provider on the client's behalf,
generate an invoice from the funds provider to the client relating the payment of the WPO.

19. The system of claim 18, wherein the computer network is the World Wide Web.

20. The system of claim 18, wherein the server is further programmed to maintain a revolving credit protocol for the client in which a repayment received from the client for a previous invoice is made available to the client for a future WPO payment request.
